(19) United States
(12) Patent Application Publication
(10) Pub. No.: US 2004/0031209 A1
(43) Pub. Date: Feb. 19, 2004

(54) Collection device for use with a gutter

(76) Inventor: John K. Porter, Huber Heights, OH (US)

Correspondence Address: A PATENT LAWYER CORP, PC, R WILLIAM GRAHAM, 22 S ST CLAIR ST, DAYTON, OH, 45402, US

(21) Appl. No.: 10/217,908

(22) Filed: Aug. 13, 2002

(51) Int. Cl. E04D 13/00; E04D 13/08; B01D 1/00; C02F 1/00; E02B 1/00

(52) U.S. Cl. 52/12; 52/16; 210/153

(57) ABSTRACT

A collection device for a gutter is provided. The device includes a housing having an upper open end sealably connectable to the gutter about a bottom opening in the gutter and a lower end and a screen extending from the lower end through the housing to the upper end. A first compartment is formed on one side of the screen within the housing to receive water and debris as they enter the bottom opening. A second compartment is formed on another side of the screen to substantially receive only water flowing through the bottom opening and into the first compartment. A down spout outlet is formed on the lower end in the second compartment. A debris outlet formed in the lower end of the first compartment and a trap door is sealably connectable to the lower end to enclose the debris outlet to contain the debris.

### FIELD OF THE INVENTION

The invention relates to a collection device for gutter. More particularly, the invention relates to device which can be retrofit to an existing gutter in order to accommodate the collection and removal of leaves, sticks and debris through the collection device.

### BACKGROUND OF THE INVENTION

It is long been a problem to prevent debris such as leaves and sticks from entering gutters which cause clogging and necessitate removal of the same. An attempt to overcome the problem includes installing a screen over the gutter to prevent debris including leaves, needles, and twigs from nearby trees, from entering the gutter. The debris in turn is intended to eventually pass over the screen onto the ground.

Such screens which exist in the art are typically metallic or plastic having an open structure which is used to limit the entry of the debris while permitting air and water flow therethrough. A drawback with the screen coverings is their ineffectiveness to stay in place during storms and windy days, requiring the replacement thereof. In addition, the loss of such covering during such times permits debris to collect in the gutter.

A further drawback is that some forms of the debris accumulates on the screen and embeds in the screen which not only produces weight and strain, but when allowed to remain for a long period induces the deterioration of the screen. For example, pine needles tend to embed in screen openings. This translates into more work requiring climbing up to the screen and removing the debris. Even if screen works as intended, the debris falls off the perimeter of the house and requires walking around the same, bending over and manually removing the debris.

A water hose or air hose has been used to aid in the removal of the debris by flushing debris down the gutter. However, this can result with clogging of the downspout with the debris and creates an unwanted mess. Further, clogging the downspout results in backups which increases the potential damage the house face board due overflowing of the soaked debris and promotes staining.

There remains a need for an improved gutter system which reduces the amount of work associated with debris removal from gutters. Accordingly, the present invention provides a simpler and easier solution to debris removal from gutters.

### SUMMARY OF THE INVENTION

It is an object to improve gutter systems.

It is another object to enable debris collection using conventional gutter systems.

It is still another object to provide a device for collecting debris from gutters.

Accordingly, the present invention is directed to a collection device for connection to a gutter which has been formed with a longitudinally defined opening in a bottom thereof to readily enable leaves, sticks and debris to fall therethrough. The device includes a housing having an upper open end sealably connectable to the gutter about the bottom opening and a lower end and a screen extending from the lower end through the housing to the upper end. A first compartment is formed on one side of the screen within the housing to receive water and debris as they enter the bottom opening. A second compartment is formed on another side of the screen to substantially receive only water flowing through the bottom opening and into the first compartment. A fluid outlet is formed on the lower end in the second compartment for connection to a conventional down spout. A debris outlet formed in the lower end of the first compartment and a trap door is sealably connectable to the lower end to enclose the debris outlet to contain the debris. The trap door is hingedly connected at one end and releasably maintained at its other end.

Other objects and advantages will be readily apparent to those skilled in the art upon viewing the drawings and reading the detailed description hereafter.

### BRIEF DESCRIPTION OF THE DRAWINGS

FIG. 1a is a side cross sectional view of an embodiment of the invention in use.

FIG. 1b is a side cross sectional view of another embodiment of the invention in use.

FIG. 2a is an end view of the FIG. 1a.

FIG. 2b is an end view of the FIG. 1b.

FIG. 3 is a top view of the invention.

FIG. 4 shows a pole for use with the invention.

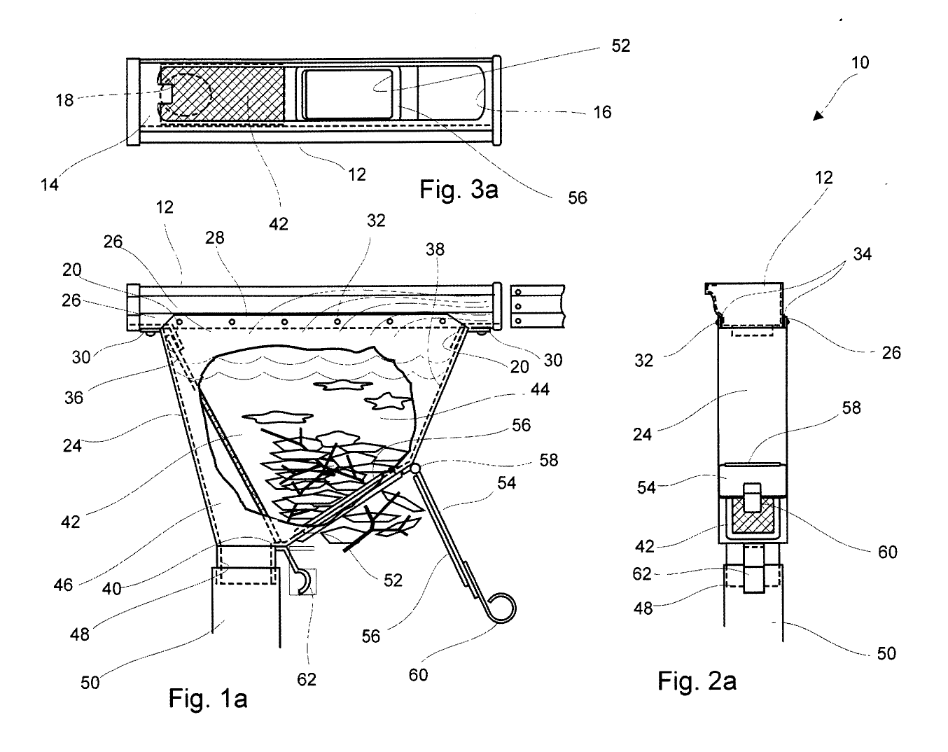

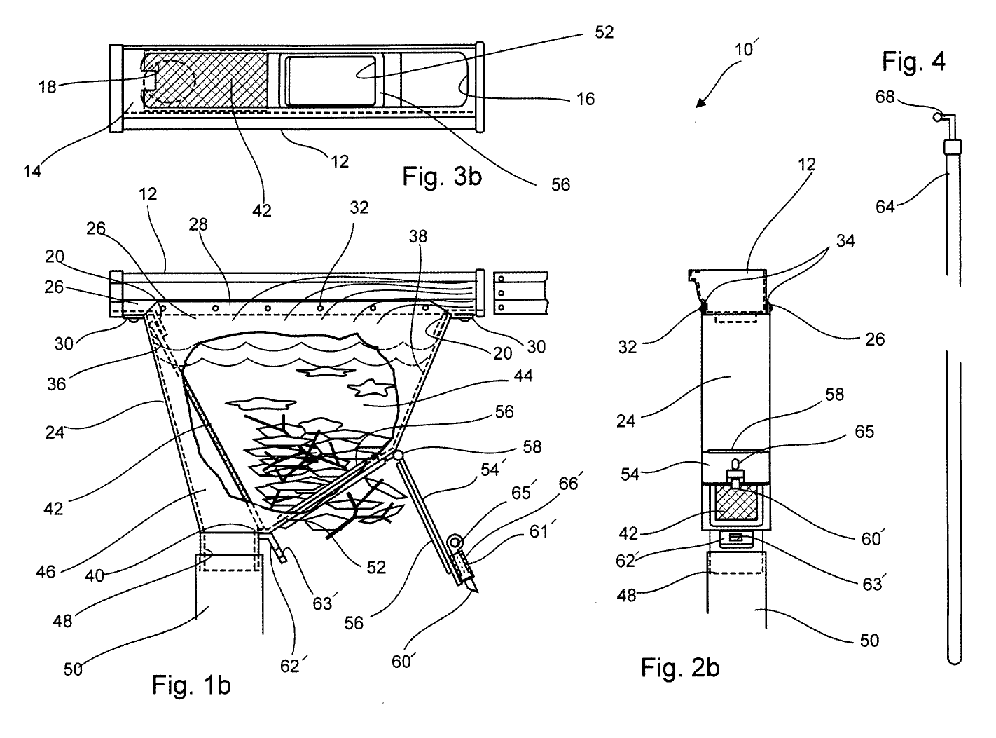

### DETAILED DECRIPTION OF THE INVENTION

Referring now to the drawings, the collection device of the present invention is generally referred to by the numerals 10 and 10′. Like numerals indicate like parts of the embodiments shown. The collection device 10 is contemplated for use integrally or retrofit with a gutter 12. The gutter 12 can be a conventional aluminum type construction and has formed in a bottom surface 14 thereof an elongated longitudinally defined opening 16, shown here to be generally rectangular in configuration. The opening 16 can be formed using tin snips or other suitable cutting device or die cut, for example. In the case of retrofitting to an existing gutter, there commonly exists a smaller oval opening 18 for a downspout connection which here is shown as a dashed line to indicate the former position thereof. Thus, the newly formed opening 16 would exchange the smaller oval opening 18. Tab portions 20 can be formed from part of the bottom surface 14 and bent downwardly for use as will be described hereinafter. The opening 16 is of a predetermined size and design to readily enable debris including leaves and sticks and the like to readily fall therethrough.

The collection device 10 can be made of aluminum, for example, to complement the gutter material. The collection device 10 includes a housing 24 having an upper open end 26 which is preferably configured sealably connect to the gutter 12 about the bottom surface opening 16. In the embodiment shown, the upper end 26 is slightly wider than the gutter 12 and includes longitudinal tabs 28 which can be attached to the outer sides of the gutter 12 and has end tabs 30 which connect to an outer part of the bottom surface 14. The tabs 28 can be connected by way of example using pop rivets 32 to secure them to the outer sides of the gutter 12 and have a sealant material 34 applied there between. The end tabs 30 can likewise include sealant material between the bottom surface 14 and tabs 30 and can be optionally riveted, however this may not be necessary to sealably hold the device 10 to the gutter 12. The tabs 20 can likewise be sealed and optionally connected to inside walls 36 and 38. The housing 24 includes a lower end 40 which will be described in more detail hereinafter.

A screen 42 extends from the lower end 40 through the housing 24 to the upper end 26. A first compartment 44 formed on one side of the screen 42 within the housing 24 to receive water and debris as they enter through the opening 16. A second compartment 46 is formed on another side of the screen 42 to substantially receive only fluid flowing through the opening 16 and into the first compartment 44.

A fluid outlet 48 is formed on the lower end 40 in the second compartment 46 and can be configured for connection to a conventional down spout 50. A debris outlet 52 is formed in the lower end 40 of the first compartment 44 and a trap door 54 is provided which preferably is sealably connectable to the lower end 40 to enclose about the debris outlet 52 to contain the debris in the first compartment 44 until the trap door 54 is opened. In this regard, a seal or gasket 56, which may include one or more pieces, is provided between the trap door 54 and debris outlet 52 of the lower end 40.

While the screen 42 is shown here as sloping from an inner portion of the lower end 40 toward side wall 36 and generally terminating adjacent the upper open end 26, it is contemplated that the screen 42 can extend up into the gutter 12. Modifications of the particular orientation shown can exist to accomplish the intended function of separating debris from the liquids into the two separate compartments 44 and 46, respectively.

The trap door 54 can be hingedly connected at one end 58, here shown upwardly disposed, and is detentably maintained at end 60 by a spring 62 which here is formed as an arcuate spring lip member which protrudes outwardly from the lower end 40 and is designed to permit the end 60 to snap into a retained sealed position. In this embodiment, the spring force constant of the spring 62 can be designed to permit the trap door 54 to open upon a predetermined weight being exerted on the door 54.

Additionally, there is provided an alternative embodiment in which the device 10′ differs in the trap door 54′ connection. Here, there is provided a lip 62′ having a retaining surface aperture 63′ therein. The end 60′ is formed with a sleeve 61′ having a ring pin 65′ biased and retained within the sleeve 61′ by a spring 66′. The spring 66′ keeps the pin 65′ normally biased through the sleeve 61′ such that a portion of the ring pin 65′ extends beyond the sleeve 61′. Retracting the ring pin 65′ with the sleeve 61′ permits the trap door 54′ to be placed in a sealed shut position and release of the ring pin 65′ thus allows the ring pin 65′ to enter the aperture 63′ and thus be retained within lip 62′. A pole 64 which has a hooked end 68 can be used to retract the pin 65′ and permit pulling the trap door 54′ open to enable removal of the debris. In this case, the trap door 54′ is securely maintained.

The above described embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

What is claimed is:

1. A collection device for connection to a gutter which has a longitudinally defined opening in a bottom thereof to readily enable debris including leaves and sticks to fall through, said device comprising:
a housing having an upper open end sealably connectable to the gutter about the bottom opening and a lower end;
a screen extending from said lower end through said housing to said upper end;
a first compartment formed on one side of said screen within said housing to receive fluid and debris as they enter the bottom opening;
a second compartment formed on another side of said screen to substantially receive only fluid flowing through the bottom opening and into said first compartment;
a fluid outlet formed on said lower end in said second compartment for connection to a conventional down spout;
a debris outlet formed in said lower end of said first compartment; and
a trap door sealably connectable to said lower end to enclose said debris outlet to contain the same.

2. The collection device of claim 1, wherein said trap door is hingedly connected to at a first end.

3. The collection device of claim 2, wherein said trap door is detentably maintained at a second end.

4. The collection device of claim 3, wherein said door releases upon a predetermined force being applied thereto.

5. The collection device of claim 1, wherein said upper end is formed a pair of longitudinally extending tabs configured for connection to sides of the gutter.

6. The collection device of claim 5, which includes another pair of tabs for connection to the bottom of the gutter.

7. The collection device of claim 1, wherein said screen is pitched with respect to the gutter.

8. The collection device of claim 1, wherein said housing is tapered having said upper end larger then lower end.

9. The collection device of claim 1, which includes an elongated member connectable to said second of said door for enabling manual opening of said trap door.

10. The collection device of claim 1, wherein said housing is made of aluminum.

11. The collection device of claim 5, wherein said tabs are connected to sides.

12. The collection device of claim 2, wherein said trap door is securely maintained at a second end by a sliding pin connected thereto, wherein said sliding pin connects to a retaining surface on said lower end.

13. The collection device of claim 12, wherein said pin is normally biased outwardly to enable maintaining of said door closed and which can be retracted to permit opening of said door.
